(19) United States
(12) Patent Application Publication
(10) Pub. No.: US 2009/0182907 A1
(43) Pub. Date: Jul. 16, 2009

(54) Data Recording Apparatus

(75) Inventors: Bernhard Deck, Weilheim (DE); Lorenzo Gulli, Espoo (FI); Werner Vogt, Dusseldorf (DE)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 12/394,585

(22) Filed: Feb. 27, 2009

Related U.S. Application Data
(63) Continuation of application No. PCT/EP2007/056963, filed on Jul. 9, 2007.

(51) Int. Cl. G06F 13/00

(52) U.S. Cl. 710/33; 710/8; 713/183

(57) ABSTRACT

A data recording apparatus is disclosed for recording production and product data output from at least one electronic device. A data collector device assigned to the electronic device records the production and product data and converts said data into transmission data to be transmitted, which are subsequently stored in a storage device. A configuration device connected between the data collector device and the storage device controls the storage of the transmission data.

### RELATED APPLICATION

This application claims priority as a continuation application under 35 U.S.C. §120 to PCT/EP2007/056963 filed as an International Application on Jul. 9, 2007 designating the U.S., the entire content of which is hereby incorporated by reference in its entirety.

### TECHNICAL FIELD

The present disclosure relates generally to a method for transmitting production and product data of an intelligent electronic device to a remote storage device or a remote storage system. The present disclosure also relates to a data recording apparatus.

### BACKGROUND INFORMATION

Electrical devices—also referred to as primary devices—appertaining to medium- and high-voltage technology such as, for example, power transformers, converter stations, line devices, power circuit-breakers, isolating switches, grounding switches, busbars, motors, generators, etc., after production and sale to the end user, are usually present at different locations and have to be monitored there and protected by protection devices. Such protection devices, which are also referred to as secondary devices or intelligent electronic devices (IED), have numerous electronic components. These electronic components of the intelligent electronic devices (IED) serve for monitoring and driving specific properties of the electrical device—of the primary device. Depending on what kind of primary device is to be monitored and/or driven, the intelligent electronic device (IED) is equipped with the requisite electronic components or elements. Such components can be for example analog input units, sensor units, I/O interface units, power supply units and processor units.

During the lifetime (operational time) of the intelligent electronic device, changes are often made to the intelligent electronic device or the components thereof; in particular, components of the intelligent electronic device are replaced by new or different components and/or the software for controlling the intelligent electronic device is updated. This is referred to hereinafter as a change in the configuration. Such changes are often carried out by the end user of the intelligent electronic device or someone commissioned by said end user. The consequence of this is that a present configuration of the intelligent electronic device (IED), characterized by production and product data, is not known in all cases to the entity whose aid is requested in the event of a fault in the intelligent electronic device, in particular is not known to the manufacturer of the intelligent electronic device. Production and product data of the intelligent electronic device (IED) are, in particular: serial number, country of production, hardware version number, software and/or firmware version number, used test data, total operating time, location of processor serial number and/or MAC address. The MAC (media access control) address, which is also referred to as hardware address, enables an unambiguous identification of a network adaptor in a network.

In an inexpedient manner, it is furthermore possible that the installed intelligent electronic devices change their installation location in such a way that an overview of the installation locations and associated configurations of the intelligent electronic devices to be monitored is no longer possible for the manufacturer.

In many cases, therefore, it is desirable for an installed intelligent electronic device to be tracked by the manufacturer with regard to installation location and change in its configuration.

When intelligent electronic devices are installed in industrial environments, in particular in medium-voltage switching stations and high-voltage switching stations, there is the problem that changes in requirements, fitted parts and configurations take place continuously in part, with the result that tracking such changes over a long period of time, in particular over the entire lifetime, is very difficult and prone to error.

Furthermore, communication within or from an existing medium-voltage switchgear installation or high-voltage switchgear installation is subject to strict safety regulations since the operational safety of the switchgear installation must not be endangered.

### SUMMARY

Knowledge of the current status or the current configuration with regard to production and product data of a specific installation of an intelligent electronic device (IED) for monitoring and/or driving a primary device appertaining to medium- and high-voltage technology is therefore useful for the monitoring and/or the maintenance of the intelligent electronic device after it has been produced and sold. Particularly for the manufacturer of the intelligent electronic device, whose aid is requested in the event of a disturbance or a fault in the intelligent electronic device, it is useful to know where a corresponding intelligent electronic device is located and how this intelligent electronic device is configured, in order that the manufacturer can directly initiate the necessary actions for rectifying the disturbance or the fault without inspecting the intelligent electronic device beforehand.

Intelligent electronic devices (IED) are used in particular in medium-voltage switchgear installations and high-voltage switchgear installations for the driving and/or monitoring of primary devices of said switchgear installations. For the power supply, therefore, it is extremely important that both the primary devices such as power transformers, converter stations, power devices, power circuit-breakers, isolating switches, grounding switches, busbars, etc. and the intelligent electronic devices (secondary devices) that monitor and/or drive said primary devices operate extremely reliably. In the event of a disturbance and/or fault in the intelligent electronic device (IED), it is necessary for said disturbance or fault to be rectified immediately, since the power supply could otherwise collapse.

A method is disclosed as to how the configuration or the production and product data of an installed intelligent electrical device can be tracked, in particular by the manufacturer thereof.

Furthermore a data recording apparatus is disclosed for recording production and product data output from at least one intelligent electronic device, which data recording apparatus enables continuous tracking of a configuration and detection of installed components of the intelligent electronic device.

A data recording method for recording production and product data output from at least one intelligent electronic device is disclosed, comprising the following steps:

a) reception of the production and product data output from the intelligent electronic device by means of at least one data collector device assigned to the intelligent electronic device;
b) processing of the received production and product data into transmission data to be transmitted by means of the data collector device;
c) outputting of the transmission data from the data collector device;
d) transmission of the transmission data output by the data collector device to a storage device by means of at least one data transmission device; and
e) storage of the transmission data transmitted to the storage device in the storage device, wherein a storage of the transmission data transmitted by means of the data transmission device is controlled by means of a configuration device connected between the data collector device and the storage device, wherein, before the configuration device receives the transmission data, a first data transmission path of the data transmission device is produced between the data collector device and the configuration device and, after the transmission of the transmission data to the configuration device, the first data transmission path is disconnected, and, before the transmission data are communicated to the storage device, a second data transmission path of the data transmission device is produced between the configuration device and the storage device.

A data recording apparatus for recording production and product data output from at least one intelligent electronic device is disclosed based on such a method. Such a data recording apparatus comprises:

a) at least one data collector device which is assigned to the intelligent electronic device and which records the production and product data output from the intelligent electronic device and which converts said data into transmission data to be transmitted;

b) a storage device for storing the transmission data provided by means of the at least one data collector device;

c) a data transmission device for transmitting the transmission data from the data collector device to the storage device; and

d) a configuration device connected between the data collector device and the storage device and serving for controlling the storage of the transmission data provided by the data collector device, and the configuration device is a portable computer device, a notebook or a laptop.

### BRIEF DESCRIPTION OF THE DRAWINGS

Exemplary embodiments of the disclosure are illustrated in the drawings and are explained in more detail in the description below.

In the drawings:

FIG. 1 shows a block diagram of an exemplary data recording apparatus, wherein a link between an intelligent electronic device (IED) to be monitored and a storage device via a configuration device is illustrated schematically;

FIG. 2 shows the data recording apparatus illustrated in FIG. 1 for a plurality of intelligent electronic devices (IED) to be monitored and also the corresponding data transmission paths to a central storage device;

FIG. 3 shows a block diagram of the exemplary operating steps of a data recording method according to the disclosure for recording production and product data output from at least one intelligent electronic device;

FIG. 4 shows a general illustration of an exemplary data recording apparatus according to the disclosure with a data transmission device between an intelligent electronic device (IED) and a storage device;

FIG. 5 shows an exemplary block diagram for elucidating a data interchange between an intelligent electronic device (IED) and a configuration device with a data collector module;

FIG. 6 shows a block diagram illustrating an exemplary configuration of a data collector module;

FIG. 7 shows a block diagram of a database function in accordance with an exemplary embodiment of the present disclosure;

FIG. 8 shows an exemplary block diagram for the automatic detection of components installed in an intelligent electronic device and transmission of product data; and

FIG. 9 shows a block diagram of an exemplary protocol for the interchange of product data.

In the figures, identical reference symbols designate identical or functionally identical components or steps.

### DETAILED DESCRIPTION

One aspect of the disclosure consists in providing, by means of a configuration device connected between a data collector device assigned to the at least one intelligent electronic device to be monitored and the storage device, an efficient control of the storage of the production and product data provided by the collector device, said data being transmitted as transmission data from the intelligent electronic device to be monitored to the storage device. The transmission data comprise, in particular, the production and product data of the intelligent electronic device (IED).

In this case, the transmission data are firstly transmitted from the collector device to the configuration device via a first data transmission path. These transmission data transmitted to the configuration device are then transmitted from the configuration device to the storage device via a second data transmission path. This firstly makes it possible that the first data transmission path and the second data transmission path do not have to be produced simultaneously. Secondly, this makes it possible that there need not be a direct data transmission path between the intelligent electronic device and the storage device.

Such a possibility of tracking changes in the configuration and changes in installed components of the intelligent electronic device makes it possible to collect data which are important for the manufacturer, that is to say production and product data of the installed electronic device, or of a plurality of installed intelligent electronic devices, in a central database, in order to be able to react rapidly in the case of a disturbance or fault in the intelligent electronic device (IED). In particular, it is advantageous that maintenance operation of an installed intelligent electronic device is facilitated by precise knowledge of the configuration and construction thereof.

A further advantage is that a single storage apparatus, which can be designed as a server system, can store all the data in a uniformly password-supported manner from a large number of intelligent electronic devices. Moreover, it is expedient that no interaction with the user of the corresponding intelligent electronic device is necessary for the data storage of production and product data of the intelligent electronic devices.

Consequently, the data recording method according to the disclosure advantageously makes it possible both to ascertain the location at which an intelligent electronic device to be monitored is situated and to interrogate customer and parameter data of the intelligent electronic device.

In an expedient manner, the production and product data comprise for example serial numbers, the country of production, hardware version numbers, software/firmware version numbers, used test data, total operating time and the location of the intelligent electronic device.

Consequently, it is a principal advantage of the present disclosure that the quality of available data about installed intelligent electronic devices in a central database or a central storage device is improved. Furthermore, in the case of the data recording method according to the disclosure for recording production and product data output from at least one intelligent electronic device, it is expedient that the configuration device has to be connected to the data transmission device only as required.

An exemplary data recording apparatus according to the disclosure for recording data output from at least one intelligent electronic device comprises:

a) at least one data collector device which is assigned to the intelligent electronic device and which records the production and product data output from the intelligent electronic device and which converts said data into transmission data to be transmitted;
b) a storage device for storing the transmission data provided by means of the at least one data collector device; and
c) a data transmission device for transmitting the transmission data from the data collector device to the storage device.

In this case, the data recording apparatus furthermore has a configuration device connected between the data collector device and the data storage device and serving for controlling the storage of the transmission data provided by the data collector device, wherein the configuration device is formed by a portable computer device, in particular by a notebook or a laptop.

Furthermore, the method according to the disclosure for recording production and product data output from at least one intelligent electronic device comprises the following steps:

a) reception of the production and product data output from the intelligent electronic device by means of at least one data collector device assigned to the intelligent electronic device;
b) processing of the received production and product data into transmission data to be transmitted by means of the data collector device;
c) outputting of the transmission data from the data collector device;
d) transmission of the transmission data output by the data collector device to a storage device by means of at least one data transmission device; and
e) storage of the transmission data transmitted to the storage device in the storage device, wherein a storage of the transmission data transmitted by means of the transmission device is controlled by means of a configuration device connected between the data collector device and the storage device, wherein, before the configuration device receives the transmission data, a first data transmission path of the data transmission device is produced between the data collector device and the configuration device (300) and, after the transmission of the transmission data to the configuration device, the first data transmission path is disconnected, and, before the transmission data are communicated to the storage device, a second data transmission path of the data transmission device is produced between the configuration device and the storage device.

In accordance with one exemplary embodiment of the present disclosure, the first data transmission path and/or the second data transmission path exist(s) only temporarily. This makes it possible that there is no need to install permanent data transmission paths that are expensive and complicated to install.

In accordance with one exemplary embodiment of the present disclosure, the first data transmission path is disconnected before the second data transmission path is set up. This makes it possible for the transmission data (comprising the production and product data) to be transmitted in direct proximity to the intelligent electronic device (IED) from the data collector device connected to the intelligent electronic device to the configuration device. The transmission of the production and product data from the configuration device to the storage device takes place at a later point in time from a different location.

In accordance with another exemplary embodiment of the present disclosure, the first data transmission path is formed by a data transmission cable. This enables extremely simple and reliable data transmission. The data transmission cable used can be a short data transmission cable having a length of a few meters, for example.

In accordance with another exemplary embodiment of the present disclosure, the first data transmission path is formed by a wireless data transmission link such as, for example, a data transmission link via a radio link or an optical data transmission link. In this case, a transmission range of this wireless data transmission link can be a short range of up to a few meters.

In accordance with another exemplary embodiment of the present disclosure, the configuration device is formed by a portable computer device, in particular by a notebook or a laptop. Together with the temporary data transmission paths, this enables extremely simple and cost-effective data transmission. The first data transmission path is produced only as required, which has the consequence of not causing complicated installations of this data transmission path. In particular, no maintenance of this data transmission path is necessary. Likewise, the second data transmission path is set up only as required.

In accordance with another exemplary embodiment of the present disclosure, the data transmission device has an unprotected data transmission path between the data collector device and the configuration device and a protected data transmission path between the configuration device and the storage device.

A link between the data collector device and the configuration device is advantageously implemented in a local environment, such that an unprotected data transmission path can be provided here, that is to say that data transmitted via this data transmission path need be neither encrypted nor protected.

On the other hand, the link between the configuration device and the storage device is provided by an ESF link and/or a GSM link and/or a GPRS link and/or an Internet link, for example, in such a way that a protected data transmission path is advantageously established here. Protection of data preferably comprises the steps of data encryption and data authentication.

In accordance with another exemplary embodiment of the present disclosure, the configuration device for controlling the storage of the data recorded by the data collector device has a data collector module. Such a data collector module can be embodied in such a way that it can record data from the at least one intelligent electronic device to be monitored and forward them to a central storage device. The data collector device advantageously has a server detector for detecting a server system in which the data are to be stored. Furthermore, the data collector device comprises a buffer store for buffering transmission data to be stored in the storage device.

It is advantageous if the storage device is embodied as a central file server. Furthermore, it is possible for a plurality of storage devices to be provided, wherein an individual storage device represents a part of a server system.

In accordance with yet another exemplary embodiment of the present disclosure, the storage device is embodied as a central file server linked to at least two different intelligent electronic devices by means of respectively assigned data transmission devices.

In accordance with yet another exemplary embodiment of the present disclosure, the production and product data output from the intelligent electronic device comprise one or more of the following: serial numbers, country of production, version number, hardware version, software/firmware version, test data records, processor serial numbers, MAC address, location and service duration.

In accordance with yet another exemplary embodiment of the present disclosure, the storage device is formed from a storage processor unit and a storage medium. The storage processor unit expediently controls a data storage of data to be stored in the storage medium.

In accordance with yet another exemplary embodiment of the present disclosure, the control—carried out by means of the configuration device—of the storage of the transmission data transmitted by means of the data transmission device comprises the following steps:

a) inputting of user identification data of a user into the configuration device;
b) acquisition of characteristic data of the configuration device;
c) registration of the user in the configuration device by means of user identification data;
d) transmission of the user identification data and the characteristic data of the configuration device from the configuration device to the storage device;
e) registration of the user in the storage device by means of the user identification data, wherein password data dependent on the user identification data are generated;
f) transmission of the password data dependent on the user identification data from the storage device to the configuration device; and
g) storage of the user identification data and/or the password data dependent on the user identification data in the configuration device. In an advantageous manner, the transmission data are encrypted and/or authenticated.

In accordance with yet another exemplary embodiment of the present disclosure, the production and product data of components of the intelligent electronic device (IED) (secondary device) are recorded, wherein the intelligent electronic device comprises one or more of the following components: analog input units, sensor units, I/O interface units, power supply units and processor units.

In accordance with yet another exemplary embodiment of the present disclosure, the transmission data are automatically buffer-stored in the configuration device via a connection thereof.

It is advantageous if, during a registration of the user in the configuration device, a user name and a user password are stored permanently in the configuration device. In accordance with yet another exemplary embodiment of the present disclosure, the password data dependent on the user identification data are formed by a data word which is long in comparison with the user identification data.

In accordance with yet another exemplary embodiment of the present disclosure, when the at least one intelligent electronic device is linked to the at least one data transmission device, an automatic outputting of the production and product data is initiated by means of the at least one data collector device assigned to the intelligent electronic device.

In accordance with a further exemplary embodiment of the present disclosure, the intelligent electronic device and the data collector device are incorporated in a common housing.

In this way it is possible to achieve the object according to the disclosure, that is to say of providing a data recording apparatus and a corresponding data recording method in which the identification of the installed intelligent electronic devices is made possible automatically, with acquisition of production and product data which are important for the manufacturer. Consequently, maintenance operation and configuration and also reconfiguration of intelligent electronic devices to be monitored are made possible in a simple manner.

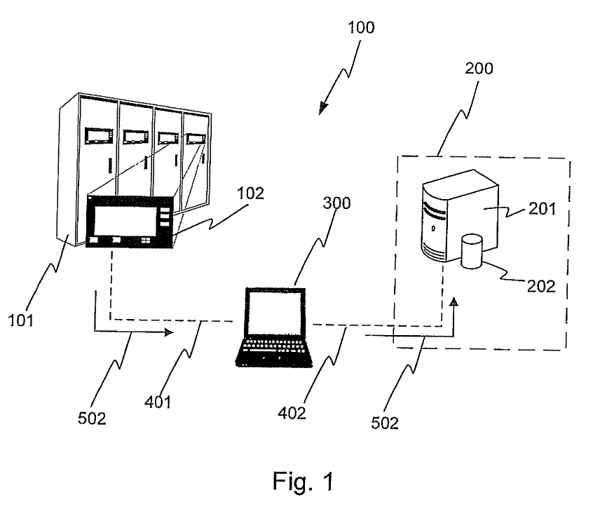

The present disclosure will be described below with reference to an exemplary embodiment. FIG. 1 shows a block diagram of an arrangement for recording production and product data output from an intelligent electronic device (IED; also referred to as secondary device). Intelligent electronic devices (IED) are used for monitoring and controlling electrical devices (also referred to as primary devices; not shown in the figures) such as, for example, power transformers, converter stations, power devices, etc., in medium-voltage switchgear installations and high-voltage switchgear installations. These primary devices can be arranged in the direct vicinity of the intelligent electronic device.

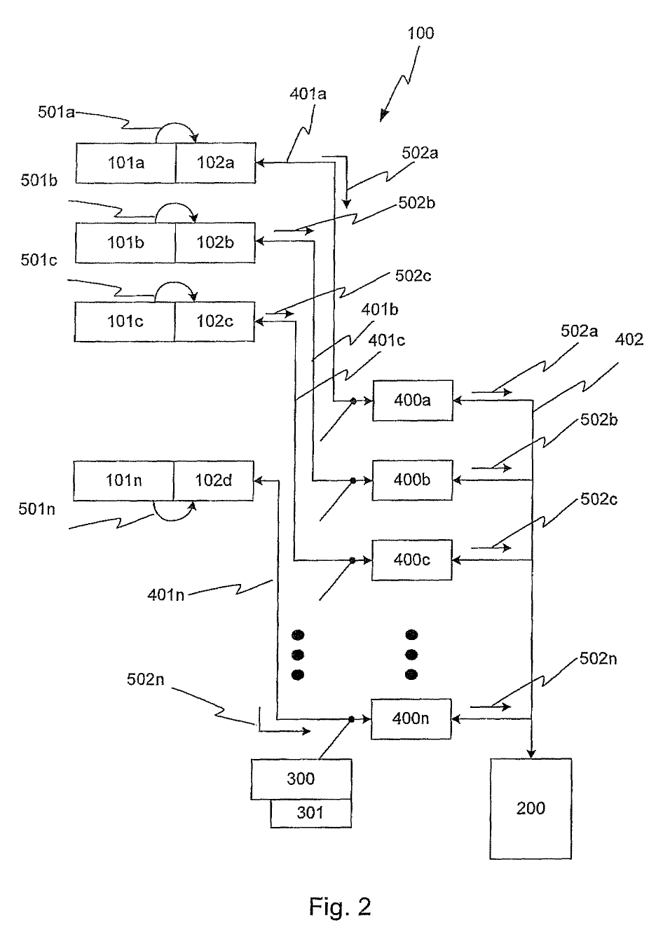

In FIG. 1, an intelligent electronic device (IED) is designated by a reference symbol 101. It should be pointed out, as described below with reference to FIG. 2, that a large number of intelligent electronic devices (IED) 101a-101n can be monitored with regard to their production and product data by the method according to the disclosure.

The intelligent electronic device (IED) 101 is to be monitored with regard to its own production and product data in order that changes to the intelligent electronic device (IED) 101 can be ascertained. For this purpose, each intelligent electronic device (IED) 101 to be monitored is assigned a data collector device 102, which records the production and product data output from the intelligent electronic device (IED) 101 and converts them into transmission data 502 to be transmitted. The data collector device 102—as shown in FIG. 1—is incorporated into the housing of the intelligent electronic device 101. As an alternative, the data collector device 102 can also be arranged in the direct vicinity of the intelligent electronic device 101.

In FIG. 1, a storage device is designated by a reference symbol 200, said storage device serving as a central unit for recording production and product data of all the intelligent electronic devices (IED) 101 to be monitored (designated by the reference symbols 101a-101n in FIG. 2).

For the transmission of the production and product data, the data collector device 102 of the intelligent electronic device (IED) 101 to be monitored is linked to a configuration device 300 via a first data transmission path 401, such that the transmission data 502 can be transmitted from the data collector device 102 to the configuration device 300. The configuration device 300 is furthermore linked to the storage device 200 via a second data transmission path 402, such that the transmission data 502 transmitted to the configuration device 300 can be further transmitted to the storage device 200. The first data transmission path 401 and the second data transmission path 402, together with the configuration device 300, in this case form a data transmission device (designated by 400a-400n in FIG. 2). The first data transmission path 402 can be formed by a data transmission cable or by a wireless data transmission link.

The first data transmission path 402 has a short length, that is to say that the data transmission cable has a length of a few meters or the wireless data transmission link has a transmission range of a few meters. This makes it possible that there is no need for data transmission cables to be laid in a complicated manner. If a data transmission cable is used for the first data transmission path 401, it can be connected to the data collector 102 and to the configuration device 300 as required. If a wireless data transmission link is used for the first data transmission path 401, a low power suffices in the case of a radio link. A wireless optical link can likewise be employed. If a radio link is employed, it must be ensured that this radio link does not influence the primary devices and also the secondary devices in the vicinity thereof since otherwise the operational safety of the medium-voltage switchgear installation and/or of the high-voltage switchgear installation could be endangered.

The data recording apparatus 100 is described in greater detail with reference to FIG. 2.

According to the disclosure, a configuration device 300 can be temporarily connected temporally successively to at least two different data collector devices 102a-102n. A respective intelligent electronic device 101a-101n is assigned to each data collector device 102a-102n. This is illustrated in FIG. 2. Consequently, a large number of intelligent electronic devices (IED) 101a-101n can be read by means of one configuration device 300, wherein transmission data 502a-502n are respectively transmitted from the respective data collector device 102a-102n to the configuration device 300 via the respective first transmission path 401a-401n.

The configuration device 300 can likewise be linked to the storage device 200 just temporarily via the second data transmission path 402, said storage device being embodied, e.g., as a central file server.

The method according to the disclosure for recording production and product data 501, 501a-501n output from at least one intelligent electronic device (IED) 101, 101a-101n has the following steps:

a) reception of the production and product data 501a-501n output from the intelligent electronic device 101, 101a-101n by means of at least one data collector device 102, 102a-102n assigned to the intelligent electronic device 101, 101a-101n;
b) processing of the received production and product data 501a-501n into transmission data 502, 502a-502n to be transmitted by means of the data collector device 102, 102a-102n;
c) outputting of the transmission data 502, 502a-502n from the data collector device 102, 102a-102n;
d) transmission of the transmission data 502, 502a-502n output by the data collector device 102, 102a-102n to the storage device 200 by means of at least one data transmission device 400a-400n; and
e) storage of the transmission data 502, 502a-502n transmitted to the storage device 200 in the storage device 200,
wherein a storage of the transmission data 502, 502a-502n transmitted by means of the transmission device 400a-400n is controlled by means of a configuration device 300 connected between the data collector device 102, 102a-102n and the storage device 200, wherein,

before the configuration device 300 receives the transmission data 502, 502a-502n from the data collector device 102, 102a-102n a first data transmission path 401, 401a-401n of the data transmission device 400a-400n is produced between the data collector device 102, 102a-102n and the configuration device 300, and, after the transmission of the transmission data 502, 502a-502n to the configuration device 300, the first data transmission path 401, 401a-401n is disconnected, and,

before the transmission data 502, 502a-502n are communicated from the configuration device 300 to the storage device 200, a second data transmission path 402, 402a-402n of the data transmission device 400a-400n is produced between the configuration device 300 and the storage device 200.

The production and product data 501a-501n output from the intelligent electronic device 101, 101a-101n permit expedient statements about location, purpose of use, operating time in service, etc., of the intelligent electronic device (IED) 101 to be monitored. Examples of the production and product data 501a-501n output comprise: serial number, country of production, version number, hardware version, software/firmware version, test data records, processor serial number, location, MAC address and service duration.

The production and product data of the intelligent electronic device (IED) 101 (also referred to as secondary device) are to be distinguished from present state data of the electrical device (also referred to as primary device). Present state data include measured values from the sensors such as, for example, an ammeter or voltmeter but also gas sensors that measure the present gas pressure in a gas-insulated switchgear installation, the factor of quality of the insulating gas of a gas-insulated switchgear installation. Further present state data can also concern the instantaneous switching state of a switch.

As a result of the storage of the production and product data 501a-501n of the intelligent electronic device (IED) 101, 101a-101n in the storage device 200, it is possible to comprehend an alteration of the production and product data 501a-501n of individual intelligent electronic devices (IED) 101 at any time, using the data stored in the storage device 200.

In particular, it is possible to track an alteration of the hardware, for example if the processor of the intelligent electronic device 101, 101a-101n was replaced owing to a defect. If a new hardware component is incorporated into the intelligent electronic device (IED) 101, 101a-101n in order to extend the functionality thereof, the production and product data 501a-501n of the intelligent electronic device (IED) 101, 101a-101n are extended by data of said new hardware component. This means that the production and product data 501a-501n change owing to the extension. A change in the location of the intelligent electronic device 101, 101a-101n can likewise be tracked. A change in the software of the intelligent electronic device 101, 101a-101n can be tracked by means of the software/firmware version.

It is furthermore possible, by evaluation of the production and product data stored on the storage device 200, to ascertain incompatibilities between the hardware of the intelligent electronic device 101 and the software used on the intelligent electronic device 101.

As illustrated in FIG. 1, the storage device 200 comprises a storage processor unit 201 and a storage medium 202. The storage processor unit 201 controls storage of the transmitted transmission data 502 as data to be stored in the storage medium 202. The design of the storage medium is known to the person skilled in the art, and so a storage medium is not explained in any greater detail here. Examples of storage media are hard disk stores, optical disks, magnetic tape stores, semiconductor media, etc. The storage device 200 can furthermore form a part of the server system.

The data recording method according to the disclosure for recording production and product data 501a-501n output from at least one intelligent electronic device (IED), 101, 101a-101n permits the storage of the transmission data 502a-502n transmitted by means of the data transmission device 400a-400n to be controlled by means of the configuration device 300 connected between the data collector device 102, 102a-102n and the storage device 200. The configuration device 300 connected between the electronic device 101, 101a-101n to be monitored and the storage device 200 can advantageously be formed by a portable computing device 300 such as a notebook, for example. By means of the configuration device 300, it is possible to obtain production and product data 501a-501n from the data collector device 102 assigned to the corresponding intelligent electronic device (IED) 101.

By means of the portable computer device 300, it is possible to install the latter in direct proximity to one of the intelligent electronic devices (IED) 101, 101a-101n. Consequently, the first data transmission path 401, 401a-401n only has to be set up over a short distance. Once the transmission data 502, 502a-502n have been transmitted by the data collector device assigned to said intelligent electronic device (IED), the first data transmission path 401, 401a-401n can be disconnected. The portable computer device 300 can subsequently be removed as far as desired from said intelligent electronic device (IED) and, at this remote location, the second data transmission path 402, 402a-402n can be set up between the portable computer device 300 and the storage device 200 and the transmission data 502 can be transmitted to the storage device 200. Consequently, it is not necessary, in particular, to produce a direct or temporally and spatially uninterrupted data link between the intelligent electronic device 101, 101a-101n and the storage device 200.

It should be pointed out that in the case of electrical devices that are also referred to as primary devices and are embodied for example as transmission devices, power generating stations, power transformers, etc., monitoring of production and product data is carried out by means of secondary devices. Such secondary devices comprise “intelligent” electronic components that can obtain the production and product data of the primary devices and can thus store information about the primary devices.

In the case of intelligent electronic devices, the requirements, the components fitted and the configurations generally change on a continuous basis, with the result that tracking such changes is very difficult and prone to error. Precise knowledge of the current state or the current configuration of one or more electronic devices of a specific installation therefore constitutes a significant advantage for the maintenance of such devices and the continuous monitoring.

Various software systems are suitable for monitoring the production and product data, which software systems can be loaded into the configuration device 300 in such a way that they bring about the technical effect of additional monitoring of the electronic devices to be monitored. The software system can be operated on the portable computer device 300, in particular, in order that production and product data of the electronic device are recorded suitably automatically by the data collector device 102 assigned to the electronic device 101. Furthermore, the software system serves to send the data suitably to a predefined storage device 200, and to store them there permanently or to make them accessible for further processing.

The entire data recording apparatus designated by the reference symbol 100 serves for recording production and product data 501 output from at least one electronic device 101. Such data transmission and recording has to be effected securely from the electronic device 101 to be monitored to the storage device 200. A link between the electronic device 101 to be monitored or the data collector device 102 assigned thereto and the configuration device 300 shown in FIG. 1 occurs in a local vicinity of the electronic device 101 to be monitored and therefore need not be protected or encrypted. Such a link—the first data transmission path—is identified by the reference symbol 401 and a dashed line in FIG. 1. On the other hand, the link between the configuration device 300 and the storage device 200 has to be secured, since data are transmitted via generally unsecured networks such as the Internet or GSM networks. Such a secured data link is identified by the reference symbol 402 in FIG. 1 and forms a protected second data transmission path, in the case of which the data are protected and encrypted.

Such protection of the data includes two steps: (i) a data encryption and (ii) a data authentication. The data source must always be known in the case of the data authentication. It is ensured in this way that the received data have been sent from a reliable file.

In order to avoid a situation in which a user who operates the configuration device 300 has to log on and authenticate himself/herself manually with respect to the storage device 200 (the central file server) each time when data are to be transmitted from the configuration device 300 to the storage device 200, the user name and the password of the user are stored within the configuration device 300 at the time of an installation of the configuration device 300 or a data collector module 301 assigned thereto (FIG. 2). Since the password therefore does not have to be input anew and the user does not have to remember the password, the latter can be generated in a long and reliably random manner, that is to say that a “complex” password is provided.

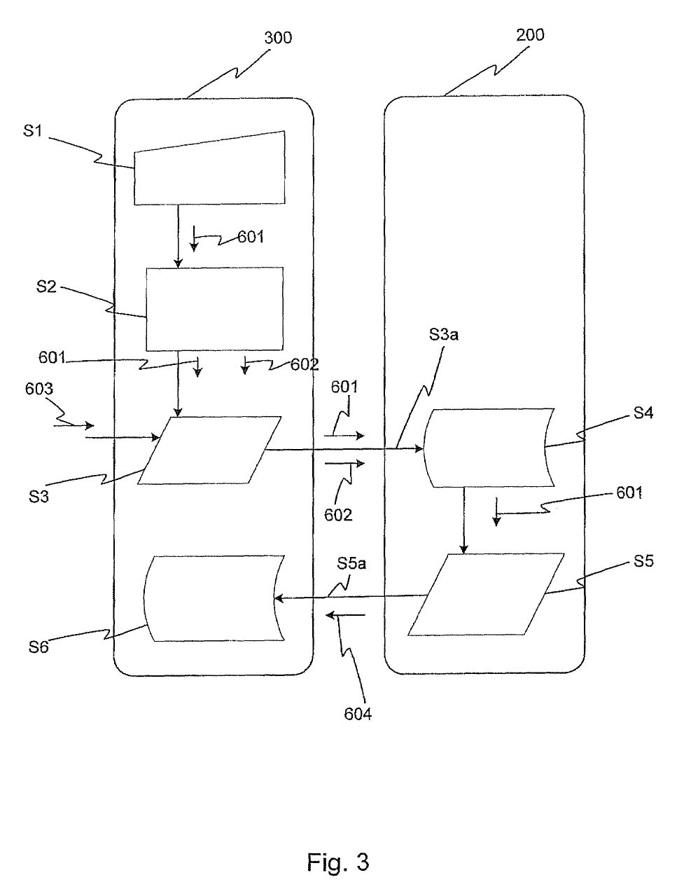

At the time of connection of the configuration device 300 to the data transmission device 401, 402 the user has to input specific information such as, for example, the name of the installation, address, company, etc., in order to ensure an unambiguous identification. The user information is sent together with hardware information such as, for example, a processor serial number, a MAC address, to the storage device 200 for registration, as described below with reference to FIG. 3. The production and product data which are recorded by means of the data collector device 102 of the electronic device 101 to be monitored can be written for example into a separate file in any format, which later, as soon as the configuration device 300 has been connected, are transmitted if appropriate automatically to the configuration device 300. The connection of the configuration device 300 will be identified by the electronic device 101 to be monitored and the data collector device 102 in such a way that data are then automatically transmitted to the configuration device 300.

The software system which is contained in the configuration device 300 and is designated as data collector module 301 can be implemented in an encrypted (encapsulated) function that is independent of the function of the electronic device to be monitored itself.

In this way, the configuration device 300 acts as a data bridge between the electronic device 101 to be monitored and a central storage device 200. In this case, the data collector module 301 assigned to the configuration device 300 works in the background and does not require user intervention to bring about data recording. Data recording is started as soon as the configuration device 300 is linked to the same network as the electronic device 101 to be monitored or the storage device 200, that is to say to the data transmission device 401, 402.

In this case, the data collector module 301 which is assigned to the configuration device 300 and which can be embodied as a software system carries out the following processes, inter alia: notification of a service, data recording, detection of a storage device 200, data buffering, temporary storage of data, sending requested data, checking availability of a corresponding storage device 200, identifying the case where the storage device 200 is not present, fetching buffered data, confirmation about data transmission, etc.

FIG. 2 shows an exemplary embodiment of the data recording apparatus according to the disclosure in greater detail. A reference symbol 200 designates a central file server system, that is to say a storage device in which all relevant production and product data of different devices to be monitored can be stored centrally. The electronic devices to be monitored are present in a number n in the example shown in FIG. 2, that is to say electronic devices (IED) 101a, 101b, 101c, . . . , 101n to be monitored.

The production and product data 501a-501n output from the respective electronic devices 101a-101n to be monitored comprise for example serial numbers of installed electronic components, the country of production, a version number, the numbers of hardware version and software/firmware version, test data records, process numbers, location, MAC addresses and the total service duration of the electronic device 101a-101n.

As is furthermore shown in FIG. 2, each electronic device (IED) 111a-101n to be monitored is assigned a data collector device 102a-102n. The data collector devices 102a-102n respectively serve to record production and product data 501a-501n output from the electronic device 101a-101n and to convert said data into transmission data 502a-502n to be transmitted. The recording of the production and product data can be effected by means of signals that are provided directly by the electronic device 101a-101n to be monitored. It is furthermore possible to provide identification elements such as RF-ID markers (radio-frequency identification markers), for example, which acquire the production and product data 501a-501n of the corresponding electronic device 101a-101n by means of transponders. Such electronic interfaces can likewise be configured as bar code markers. It is furthermore possible to read out the information about specific production and product data by means of optical interfaces.

The data collector devices 102a-102n assigned to the electronic devices 101a-101n to be monitored are linked to the storage device 200 via data transmission devices 400a-400n. It should be pointed out here that, although only one storage device 200 for storing all the relevant data of the electronic devices 101a-101n to be monitored is shown in accordance with the exemplary embodiment shown in FIG. 2, two or more storage devices 200 or file servers can be provided.

The data transmission devices 400a-400n respectively comprise unprotected, first data transmission paths 401a-401n (reference symbol 401 in FIG. 1) and protected, second data transmission paths 402. The unprotected, first data transmission paths 401a-401n are situated in a local vicinity of the electronic device 101a-101n to be monitored and therefore comprise no encryption or authentication of production and product data to be acquired. The configuration device 300 is inserted between the respective first data transmission path 401a-401n and the respective second data transmission path 402, for the transmission of the transmission data from the respective data collector device 102a-102n into the data transmission device 400a-400n.

Although only one configuration device 300 with a data collector module 301 assigned thereto is shown in FIG. 2, it may be expedient to provide different configuration devices 300 which can respectively be connected to an unprotected data transmission path 401a-401n of the data transmission device 400a-400n. The functioning of the individual configuration devices 300 with regard to storage of transmission data 502a-502n to be transmitted is as described above with reference to FIG. 1. The transmission data 502a-502n to be transmitted that are recorded by the configuration device 300 are fed to the storage device 200 via the protected data transmission path 402. The configuration devices 300 connected between respective data collector devices 102a-102n of the devices 101a-101n to be monitored in this case serve for controlling the storage of the transmission data 502a-502n provided by the data collector device 102a-102n.

FIG. 3 illustrates a flowchart for elucidating a data recording method for recording production and product data 501a-501n output from at least one electronic device 101a-101n to be monitored in accordance with an exemplary embodiment of the present disclosure. For recording the production and product data 501a-501n, the latter are firstly received by means of at least one data collector device 102a-102n assigned to the electronic device 101a-101n to be monitored. The received production and product data 501a-501n are then processed into transmission data 502a-502n to be transmitted.

Afterward, the transmission data 502a-502n are output from the data collector device 102a-102n and are transmitted from the data collector device 102a-102n to a storage device 200 by means of at least one data transmission device 400a-400n. Finally, the transmitted transmission data 502a-502n are stored as data to be stored in the storage device 200.

Storage of the transmission data 502a-502n transmitted by means of the data transmission device 400a-400n as data to be stored is controlled by means of the at least one configuration device 300 connected between the data collector device 102a-102n and the storage device 200.

The control—carried out by means of the configuration device 300—of the storage of the transmission data 502a-502n transmitted by means of the at least one data transmission device 400a-400n is explained in detail below. In this case, in FIG. 3, the reference symbol 300 designates a configuration device and the reference symbol 200 designates a storage device in such a way that the illustration shows in which of said devices the respective steps S1, S2, S3, S3a, S4, S5 and S6 are carried out.

In a first step S1, user identification data of a user are input into the configuration device 300. These data that are input are stored as user identification data 601 and acquired together with characteristic data 602 of the configuration device in a subsequent step S2.

Finally, the user is registered in the configuration device 300 by means of the user identification data 601. The user identification data 601 are subsequently transmitted, in the subsequent step S3a, together with the characteristic data 602 of the configuration device 300 from the configuration device 300 to the storage device 200.

In a step S4, the user is registered in the storage device 200 by means of the user identification data 601, wherein password data 604 dependent on the user identification data 601 are generated in a subsequent step S5.

The password data 604 dependent on the user identification data 601 are transmitted from the storage device 200 to the configuration device 300 in a step S5a. It is subsequently possible, in a step S5, to store the user identification data 601 and/or the password data 604 dependent on the user identification data 601 in the configuration device 300.

It should be pointed out here that during registration of the user in the configuration device 300 by means of step S3, a user name and a user password 603 can be stored permanently in the configuration device 300.

After such permanent storage of user name and user password, it is possible that when the at least one electronic device 101a-101n to be monitored is linked to the at least one data transmission device 400a-400n, automatic outputting of the production and product data 501a-501n is initiated by means of the at least one data collector device 102a-102n assigned to the at least one electronic device 101a-101n to be monitored.

The storage device 200, that is to say a central server system, replies with an automatically generated, descriptive and unambiguous user name and an automatically generated, long (“complex”) password which will be stored within the configuration device 300 and used for future applications in order to authenticate and encrypt data which are intended to be sent to the storage device 200.

The password data 604 dependent on the user identification data 601 are thus formed by a data word which is long in comparison with the user identification data 601.

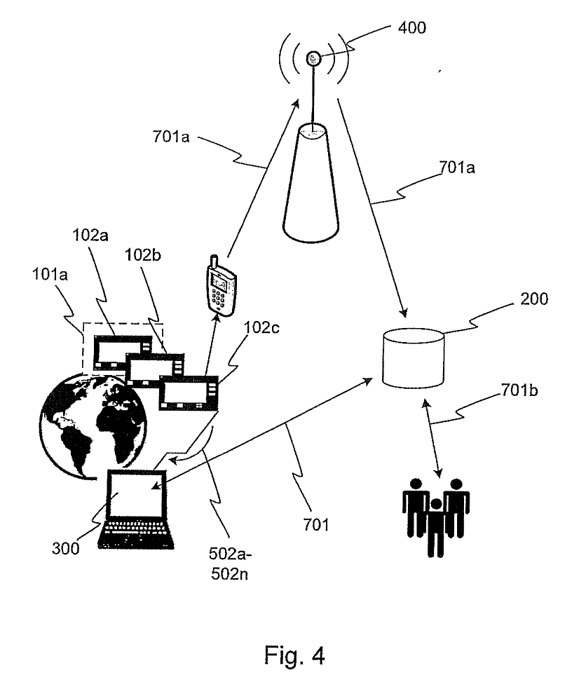

FIG. 4 shows an overview diagram of the data recording apparatus according to the disclosure for recording production and product data output from at least one electronic device 101a-101n. Just one electronic device 101a with the associated data collector device 102a is illustrated by way of example in FIG. 4.

As soon as the corresponding transmission data 502a-502n have been transmitted to the configuration device 300, they are ready for further transmission to the central storage device 200. This can be effected on the one hand via a direct data link 701 and on the other hand via a radio link, such as, for instance, a mobile radio network 701a. It should be pointed out that the method according to the disclosure for recording production and product data 501a-501n output from at least one electronic device 101a-101n is not restricted to a specific data transmission data 400. Via a further communication line 701b, finally, the storage device 200 can be accessed by call centers, an operator, controller, etc.

It should be pointed out that the transmission data 502a-502n to be transmitted can likewise be fed to the storage device 200 by means of an Internet protocol such as, for instance, e-mail in the XML format, for example.

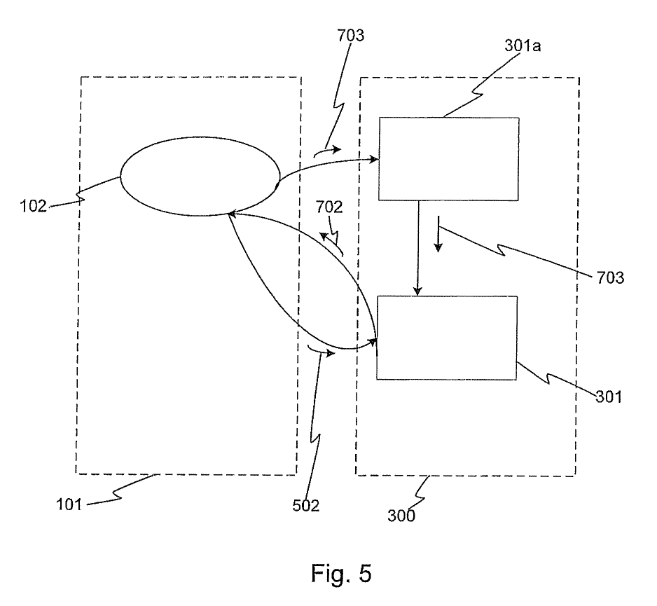

FIG. 5 shows the data interchange between an electronic device 101 and a configuration device 300 in greater detail. The electronic device 101 has a data collector device 102 that records production and product data (not illustrated in this figure) from the electronic device 101. The data interchange with external units contained in the configuration device 300 is effected by means of this data collector device 102 assigned to the electronic device 101.

The configuration device 300 has a data collector 301 and a data notification service device 301a. A bidirectional link is established between the data collector device 102 of the electronic device 101 and the data collector module 301 of the configuration device 300, via which link transmission data 502 are transmitted from the electronic device 101 to the configuration device 300 in response to a transmission of a data request signal 702 sent from the data collector module 301 of the configuration device 300 to the data collector device 102 of the electronic device 101.

Between the data collector device 102 and the notification service device 301a of the configuration device 300 there is a unidirectional link in such a way that a data type signal can be transmitted from the data collector device 102 to the notification service unit 301a.

Within the configuration device 300, finally, the data type signal 703 is fed from the notification service unit 301a to the data collector module 301. It should be pointed out that one or both of the units data collector module 301 and notification service unit 301a can be designed as software modules.

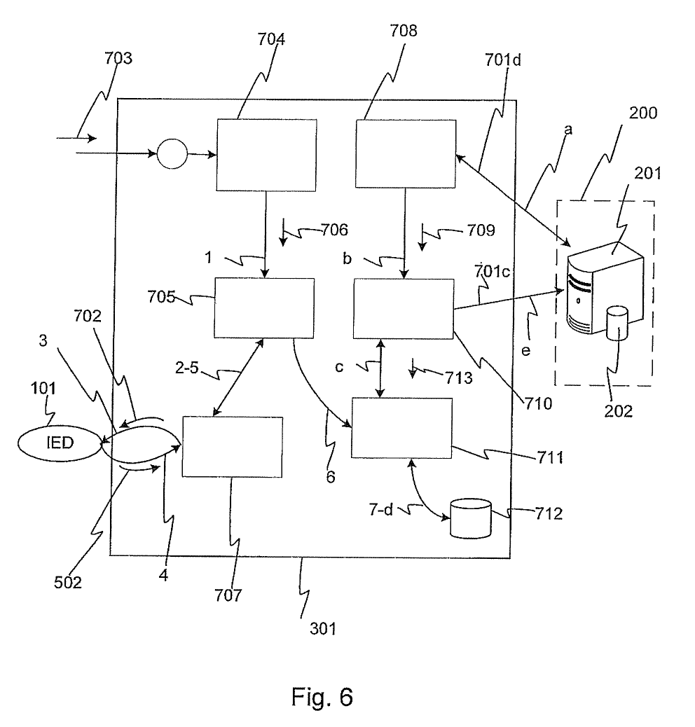

Finally, FIG. 6 shows the data collector module 301 illustrated within the configuration device 300 in FIG. 5, in greater detail. FIG. 6 schematically illustrates the links of the data collector module 301 to external units, that is to say the electronic device (IED) 101 and the storage device 200. Transmission data 502 are fed from the electronic device 101 to the data collector module 301, while the data collector module 301 sends a data request signal 702 for requesting data to the electronic device 101, as described above with reference to FIG. 5.

Furthermore, the data collector module 301 receives the data type signal 703 described above. The data type signal 703 is fed to a service notification unit 704, which finally generates a first request signal 706, which is fed to a data collector 705. The data collector 705 is linked via a bidirectional link to a connection unit 707, which, for its part, can interchange data request signals 702 and transmission data 502 with the external electronic device 101.

Furthermore, the data collector 705 of the data collector module 301 is linked via a unidirectional link to a data buffer 711, which serves for buffering data and which is linked bidirectionally to a local buffer 712.

Furthermore, the data collector module 301 has a server detector unit 708, which outputs a second request signal 709 to a data gateway 710. The data gateway 710 is linked to the data buffer 711 in such a way that a fetch signal 713 output from the data gateway 710 can be fed to the data buffer 711. Consequently, buffered data stored either in the data buffer 711 or in the local buffer 712 can be fetched and can be fed to the storage device 200 via the data link 701c. As explained above, the storage device 200 comprises a storage processor unit 201 and a storage medium 202. The storage processor unit 201 furthermore receives a “ping” signal from the server detector unit 708 via a further data link 701d.

It should be pointed out that the data collector module 301 and internal components thereof can be embodied as software units. If such a configuration is implemented on a computer unit, a service function is likewise implemented and runs in the background when the configuration tool is started.

The data are stored within the data collector module 301, more precisely in the data buffer 711 or the local buffer 712, until the server detector unit 708 has established a valid Ethernet link to a storage device or service database. In this case, the data are transmitted via the data gateway 710 to the database by means of an e-mail service or a web service.

In detail, the units which are arranged in the data collector module 301 and are preferably embodied as software modules have the following functions:

the service notification unit 704 checks the availability of a configuration unit;
the data collector 705 undertakes fetching of relevant data from the configuration unit;
the server detector unit 708 checks the availability of a data destination, that is to say of a server, such as the storage device 200, for example;
the data buffer 711 is a local buffer for recorded data;
the data gateway 710 sends data to a specific location, to the storage device 200 in this exemplary embodiment.

A data flow between the individual modules is identified by the reference symbols 1, 2, 3, 4, 5, 6, 7, a, b, c, d and e within the data collector module 301.

In this case, the designated data flows can serve the following functions:
1: a new protection unit is detected;
2: a specific unit is called up to record data;
3: data are requested by the protection unit;
4: requested data are sent;
5, 6, 7: data are buffered;
a: checking server availability;
b: server disconnected;
c, d: fetching buffered data; and
e: data sent.

It should be pointed out that the data flows designated by the reference symbols a, b, c, d and e are carried out in parallel with those data flows that are designated by the reference symbols 1, 2, 3, 4, 5, 6 and 7.

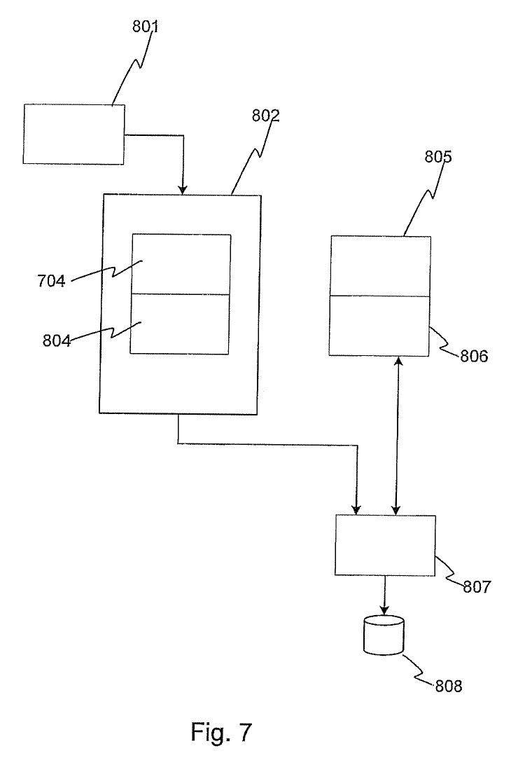

FIG. 7 is a flowchart for illustrating the database function. A web service providing unit 801 supplies data to a data processing device 802, which comprises a data validation unit 803 and a data transformation unit 804. The data processing device 802 is linked to a data access layer 807. The data access layer 807 can furthermore access an SQL server unit 808. It is furthermore possible to perform data inputting via a graphical user interface unit 805, and the data that are input are analyzed in a data analysis unit 806 connected downstream. The graphical user interface unit 805/the data analysis unit 806 are linked to the data access layer 807 via a bidirectional link. The SQL server unit 808 can be replicated in a further database (not shown in FIG. 7) via the data access layer 807. This arrangement of two databases enables increased security since the further database acts as a backup database and can be installed in a manner not exposed to a public network. The graphical user interface unit 805/the data analysis unit 806 are then connected there.

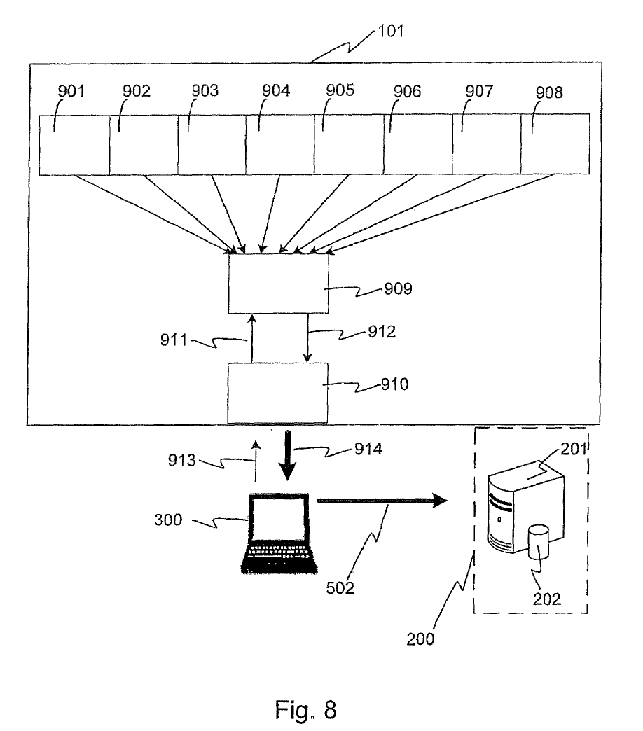

FIG. 8 shows an electronic device 101 with regard to an automatic detection of installed components in an electronic device, IED 101 and a transmission of production and product data in more detail. FIG. 8 furthermore shows the storage device 200 containing the storage processor unit 201 and the storage medium 202. The configuration device 300 once again links the electronic device 101 to the storage device 200. For this purpose, there is a possibility of data interchange between the electronic device 101 and the configuration device 300, that is to say that information reply data 914 are fed to the configuration device 300 from the electronic device 101 in response to information request data 913 sent to the electronic device 101 by the configuration device 300. The configuration device 300 then transfers the relevant data about the installed components in the electronic device 101 to the storage device 200 as soon as a data link exists. The storage processor unit 201 of the storage device 200 provides storage of the data to be stored in the storage medium 202.

Detection of installed components in an electronic device 101 is discussed in more detail below. In an electronic device, changes in requirements, installed components and configurations occur on a continuous basis in such a way that tracking these changes becomes extremely prone to error and difficult. In order to solve this problem, the disclosure provides an automatic detection of installed components, wherein such components can comprise hardware components, software components and configuration units.

The electronic device 101 has an information recording unit 909 for recording the information about the installed components and a communication unit 910 for communication to outside the electronic device 101. The communication unit 910 interchanges the abovementioned signals, that is to say information request data 913 and information reply data 914, with the external configuration device 300.

Information signal data 911 are sent to the information recording unit 909 by the communication unit 910, whereupon the information recording unit 909 can communicate an information reply signal 912 to the communication unit 910. In detail, the information about the components installed in the electronic device 101 comprises the following (it should be pointed out that the disclosure is not restricted to this exemplary embodiment, rather further information about installed components can be provided):

a basic information item 901, which comprises for example a participation of the electronic device IED 101, a version of the transmitted data format structures, a serial number of the electronic device IED 101, etc.;
an administration information item 902, which comprises for example the project name for the electronic device 101 that is allocated by the customer, the name of the electronic device 101, a postal address where the electronic device 101 is situated, etc;
a firmware/software information item 903, which comprises information about firmware, that is to say a hardware component, where the firmware is situated, a firmware/revision, revision data, etc.;
a hardware information item 904, which comprises information about the type of a component, a version text, a location or slot where it is situated, a serial number, a date of manufacture etc.;
an application description 905, which comprises information about applications such as a file name of the application/applications, a date of the last file change, a date of the last downloading etc.;
an application information item 906, which contains information about installed applications;
a location information item 907 comprising information about a present postal address; and
other information items 908.

A data flow between the software components described can be summarized as follows: a computer unit requests data; a communication part detects the request and requests IED information about the electronic device 101; a recording part records all the requested information from the various sources into a given structured data format, such as XML, for example; recorded information is sent to the communication part, that is to say the communication unit 910, and the requested information is transmitted.

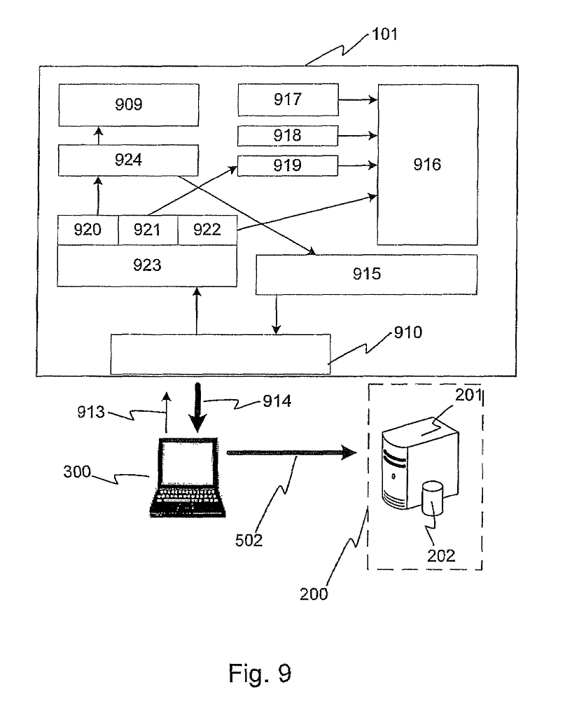

FIG. 9 illustrates a protocol for a product data interchange. FIG. 9 shows such a protocol within the electronic device 101 in more detail. The components arranged outside the electronic device 101 correspond to those in FIG. 8 and have been described above. In this case, the communication unit 910 once again serves for data interchange with the externally arranged configuration device 300 in the form of information reply data 914 and information request data 913.

After the information request data 913 have been fed via the communication unit 910, they are “parsed” as incoming commands, that is to say broken down into a data request command 920, a start command 921 and a stop command 922. The next step takes place in an information recording and format unit 924 and an information recording unit 909. The protocol for a product data interchange in the electronic device 101 furthermore has a sequence unit 916, which receives information about a new network link 917, about a change in a configuration 918 and a start command 919, which is fed from the unit 921. Connected downstream of the sequence unit 916 is a sending unit 915, which is linked to the communication unit 910, for sending data to the configuration device 300.

The present disclosure thus makes it possible to provide a data recording apparatus and a corresponding data recording method in which the identification of installed electronic devices is made possible automatically, with acquisition of production and product data which are important for the manufacturer. In an expedient manner, maintenance operation and a configuration of electronic devices to be monitored are made possible efficiently.

Although the present disclosure has been described above on the basis of exemplary embodiments, it is not restricted thereto, but rather can be modified in diverse ways.

Moreover, the disclosure is not restricted to the application possibilities mentioned.

It will be appreciated by those skilled in the art that the present invention can be embodied in other specific forms without departing from the spirit or exemplary characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

In the figures, identical reference symbols designate identical or functionally identical components or steps.

| | |
|---|---|
| 100 | Data recording apparatus |
| 101, 101a-101n | Electronic device, IED |
| 102, 102a-102n | Data collector device |
| 200 | Storage device |
| 201 | Storage processor unit |
| 202 | Storage medium |
| 300, 300a-300n | Configuration device |
| 301 | Data collector module |
| 301a | Notification service unit |
| 400, 400a-400n | Data transmission device |
| 401, 401a-401n | Unprotected data transmission path |
| 402 | Protected data transmission path |
| 501a-501n | Production and product data |
| 502, 502a-502n | Transmission data |
| 601 | User identification data |
| 602 | Characteristic data of the electronic device |
| 603 | Password |
| 604 | Password data |
| 701 | Direct data link |
| 702 | Data request signal |
| 703 | Data type signal |
| 704 | Service notification unit |
| 705 | Data collector |
| 706 | First request signal |
| 707 | Connection unit |
| 708 | Server detector unit |
| 709 | Second request signal |
| 710 | Data gateway |
| 711 | Data buffer |
| 712 | Local buffer |
| 713 | Fetch signal |
| 801 | Web service providing unit |
| 802 | Data processing device |
| 803 | Data validation unit |
| 804 | Data transformation unit |
| 805 | Graphical user interface unit |
| 806 | Data analysis unit |
| 807 | Data access layer |
| 808 | SQL server unit |
| 901 | Basic information |
| 902 | Administration information |
| 903 | Firmware/software information |
| 904 | Hardware information |
| 905 | Application description |
| 906 | Application information |
| 907 | Location information |
| 908 | Other information |
| 909 | Information recording unit |
| 910 | Communication unit |
| 911 | Information signal |
| 912 | Information reply signal |
| 913 | Information request data |
| 914 | Information reply data |
| 915 | Sending unit |
| 916 | Sequencer unit |
| 917 | New network link |
| 918 | Configuration changed |
| 919 | Start command |
| 920 | Data request |
| 921 | Start |
| 922 | Stop |
| 923 | Parsing of incoming commands |
| 924 | Information recording and format unit |

What is claimed is:

1. A data recording method for recording production and product data output from at least one intelligent electronic device, comprising the following steps:
a) reception of the production and product data output from the intelligent electronic device by means of at least one data collector device assigned to the intelligent electronic device;
b) processing of the received production and product data into transmission data to be transmitted by means of the data collector device;
c) outputting of the transmission data from the data collector device;
d) transmission of the transmission data output by the data collector device to a storage device by means of at least one data transmission device; and
e) storage of the transmission data transmitted to the storage device in the storage device, wherein a storage of the transmission data transmitted by means of the data transmission device is controlled by means of a configuration device connected between the data collector device and the storage device, wherein, before the configuration device receives the transmission data, a first data transmission path of the data transmission device is produced between the data collector device and the configuration device and, after the transmission of the transmission data to the configuration device, the first data transmission path is disconnected, and, before the transmission data are communicated to the storage device, a second data transmission path of the data transmission device is produced between the configuration device and the storage device.

2. The method as claimed in claim 1, wherein the intelligent electronic device is a secondary device of an electrical switchgear installation, or of a medium- or high-voltage switchgear installation.

3. The method as claimed in claim 1, wherein the intelligent electronic device comprises one element or a plurality of elements from the following list: analog input units, sensor units, I/O interface units, power supply units and processor units.

4. The method as claimed in claim 1, wherein the production and product data describe the configuration of the intelligent electronic device and comprise one element or a plurality of elements from the following list: serial number, country of production, hardware version number, software and/or firmware version number, used test data, total operating time, location, processor serial number and MAC address.

5. The method as claimed in claim 1, wherein the first data transmission path and the second data transmission path exist only temporarily.

6. The method as claimed in claim 1, wherein the first data transmission path is disconnected before the second data transmission path is set up.

7. The method as claimed in claim 1, wherein the first data transmission path is formed by a data transmission cable which is connected to the data collector device and/or to the configuration device before the transmission of the transmission data and is disconnected from the data collector device and/or the configuration device after the transmission of the transmission data (502a-502n).

8. The method as claimed in claim 1, wherein the first data transmission path is formed by a wireless data transmission link, wherein the configuration device is brought into transmission range with respect to the data collector device before the first data transmission path has been set up, and the configuration device is brought out of transmission range with respect to the data collector device after the transmission of the transmission data.

9. The method as claimed in claim 1, wherein the second data transmission path is provided by means of a GSM link and/or an Internet link, and wherein the second data transmission path is, in particular, a protected data transmission path.

10. The method as claimed in claim 1, wherein the configuration device is a portable computer device, a notebook or a laptop.

11. The method as claimed in claim 1, wherein the transmission data are automatically buffer-stored in the configuration device when the data collector device is connected to the configuration device.

12. The method as claimed in claim 1, wherein when the intelligent electronic device is connected to the at least one data transmission device, an automatic outputting of the production and product data is initiated by means of the at least one data collector device assigned to the intelligent electronic device.

13. The method as claimed in claim 1, wherein the control—carried out by means of the configuration device of the storage of the transmission data transmitted by means of the data transmission device comprises the following steps:
a) inputting of user identification data of a user into the configuration device;
b) acquisition of characteristic data of the configuration device (300);
c) registration of the user in the configuration device by means of user identification data;
d) transmission of the user identification data and the characteristic data of the configuration device from the configuration device to the storage device;
e) registration of the user in the storage device by means of the user identification data, wherein password data dependent on the user identification data are generated;
f) transmission of the password data dependent on the user identification data from the storage device to the configuration device; and
g) storage of the user identification data and/or the password data dependent on the user identification data in the configuration device.

14. The method as claimed in claim 1, wherein the transmission data are encrypted and/or authenticated.

15. The method as claimed in claim 1, wherein during a registration of the user in the configuration device, a user name and a user password are stored permanently in the configuration device.

16. The method as claimed in claim 1, wherein the password data dependent on the user identification data are formed by a data word which is long in comparison with the user identification data.

17. A data recording apparatus for recording production and product data output from at least one intelligent electronic device based on the method as claimed in claim 1, comprising:
a) at least one data collector device which is assigned to the intelligent electronic device and which records the production and product data output from the intelligent electronic device and which converts said data into transmission data to be transmitted;
b) a storage device for storing the transmission data provided by means of the at least one data collector device;
c) a data transmission device for transmitting the transmission data from the data collector device to the storage device; and
d) a configuration device connected between the data collector device and the storage device and serving for controlling the storage of the transmission data provided by the data collector device, and the configuration device is a portable computer device, a notebook or a laptop.

18. The data recording apparatus as claimed in claim 17, wherein the intelligent electronic device is a secondary device of an electrical switchgear installation, in particular of a medium- or high-voltage switch gear installation.

19. The data recording apparatus as claimed in claim 17, wherein the intelligent electronic device comprises one element or a plurality of elements from the following list: analog input units, sensor units, I/O interface units, power supply units and processor units.

20. The data recording apparatus as claimed in claim 17, wherein the production and product data describe the configuration of the intelligent electronic device and comprise one element or a plurality of elements from the following list: serial number, country of production, hardware version number, software and/or firmware version number, used test data, total operating time, location, processor serial number and MAC address.

21. The data recording apparatus as claimed in claim 17, wherein the first data transmission path does not exist simultaneously with the second data transmission path.

22. The method as claimed in claim 2, wherein the intelligent electronic device comprises one element or a plurality of elements from the following list: analog input units, sensor units, I/O interface units, power supply units and processor units.

23. The method as claimed in claim 3, wherein the production and product data describe the configuration of the intelligent electronic device and comprise one element or a plurality of elements from the following list: serial number, country of production, hardware version number, software and/or firmware version number, used test data, total operating time, location, processor serial number and MAC address.

24. The method as claimed in claim 4, wherein the first data transmission path and the second data transmission path exist only temporarily.

25. The method as claimed in claim 5, wherein the first data transmission path is disconnected before the second data transmission path is set up.

26. The method as claimed in claim 6, wherein the first data transmission path is formed by a data transmission cable which is connected to the data collector device and/or to the configuration device before the transmission of the transmission data and is disconnected from the data collector device and/or the configuration device after the transmission of the transmission data.

27. The method as claimed in claim 6, wherein the first data transmission path is formed by a wireless data transmission link, wherein the configuration device is brought into transmission range with respect to the data collector device before the first data transmission path has been set up, and the configuration device is brought out of transmission range with respect to the data collector device after the transmission of the transmission data.

27. The method as claimed in claim 8, wherein the second data transmission path is provided by means of a GSM link and/or an Internet link, and wherein the second data transmission path is, in particular, a protected data transmission path.

28. The method as claimed in claim 9, wherein the configuration device is a portable computer device, a notebook or a laptop.

29. The method as claimed in claim 10, wherein the transmission data are automatically buffer-stored in the configuration device when the data collector device is connected to the configuration device.

30. The method as claimed in claim 11, wherein when the intelligent electronic device is connected to the at least one data transmission device, an automatic outputting of the production and product data is initiated by means of the at least one data collector device assigned to the intelligent electronic device.

31. The method as claimed in claim 12, wherein the control—carried out by means of the configuration device of the storage of the transmission data transmitted by means of the data transmission device comprises the following steps:
a) inputting of user identification data of a user into the configuration device;
b) acquisition of characteristic data of the configuration device;
c) registration of the user in the configuration device by means of user identification data;
d) transmission of the user identification data and the characteristic data of the configuration device from the configuration device to the storage device;
e) registration of the user in the storage device by means of the user identification data, wherein password data dependent on the user identification data are generated;
f) transmission of the password data dependent on the user identification data from the storage device to the configuration device; and
g) storage of the user identification data and/or the password data dependent on the user identification data in the configuration device.

32. The method as claimed in claim 13, wherein the transmission data are encrypted and/or authenticated.

33. The method as claimed in claim 14, wherein during a registration of the user in the configuration device, a user name and a user password are stored permanently in the configuration device.

34. The method as claimed in claim 15, wherein the password data dependent on the user identification data are formed by a data word which is long in comparison with the user identification data.

35. A data recording apparatus for recording production and product data output from at least one intelligent electronic device based on the method as claimed in claim 16, comprising:
a) at least one data collector device which is assigned to the intelligent electronic device and which records the production and product data output from the intelligent electronic device and which converts said data into transmission data to be transmitted;
b) a storage device for storing the transmission data provided by means of the at least one data collector device;
c) a data transmission device for transmitting the transmission data from the data collector device to the storage device; and
d) a configuration device connected between the data collector device and the storage device and serving for controlling the storage of the transmission data provided by the data collector device, and the configuration device is a portable computer device, a notebook or a laptop.

36. The data recording apparatus as claimed in claim 18, wherein the intelligent electronic device comprises one element or a plurality of elements from the following list: analog input units, sensor units, I/O interface units, power supply units and processor units.

37. The data recording apparatus as claimed in claim 19, wherein the production and product data describe the configuration of the intelligent electronic device and comprise one element or a plurality of elements from the following list: serial number, country of production, hardware version number, software and/or firmware version number, used test data, total operating time, location, processor serial number and MAC address.

38. The data recording apparatus as claimed in claim 20, wherein the first data transmission path does not exist simultaneously with the second data transmission path.
